(19) United States
(12) Patent Application Publication
(10) Pub. No.: US 2026/0087696 A1
(43) Pub. Date: Mar. 26, 2026

(54) IMAGE PROCESSING METHOD, DEVICE AND MEDIUM

(71) Applicant: Beijing Zitiao Network Technology Co., Ltd., Beijing (CN)

(72) Inventor: Yang BAI, Beijing (CN)

(21) Appl. No.: 19/267,318

(22) Filed: Jul. 11, 2025

(30) Foreign Application Priority Data
Sep. 26, 2024 (CN) 202411356735.8

(51) Int. Cl. G06T 11/40; G06T 5/50; G06T 5/70; G06T 5/73

(52) U.S. Cl. CPC G06T 11/40; G06T 5/50; G06T 5/70; G06T 5/73; G06T 2207/20192; G06T 2207/20221

(57) ABSTRACT

Embodiments of the present disclosure relate to an image processing method, a device, and a medium, the method includes: obtaining a target image; wherein the target image is an image obtained by performing a deformation process on a first image; obtaining a position offset corresponding to a pixel in the target image based on a pixel position in the target image and a pixel position in the target image; and performing anti-aliasing processing on the target image based on the position offset corresponding to the pixel in the target image to obtain a result image; wherein a pixel with a larger position offset corresponds to a larger anti-aliasing processing intensity.

### CROSS-REFERENCE TO RELATED APPLICATION

This application claims priority to Chinese Patent Application No. 202411356735.8 filed on September 26, 2024, the disclosure of which is incorporated herein by reference in its entirety as part of this application.

### TECHNICAL FIELD

The present disclosure relates to the technical field of image processing, and more particularly to an image processing method, an apparatus, a device, and a medium.

### BACKGROUND

Nowadays, more and more ordinary users, professional edit engineers and other people need to use multimedia edit software to edit images, so as to obtain images that meet their needs. Through research, the inventors have found that the images subjected to deformation treatment usually have jaggies, and the poor anti-aliasing treatment method for the images having jaggies in the related art usually leads to the obtained image being blurred on the whole and the definition is poor.

### SUMMARY

In order to solve the above-described technical problem or at least partially solve the above-described technical problem, the present disclosure provides an image processing method, an apparatus, a device, and a medium.

Embodiments of the present disclosure provide an image processing method, the method includes: obtaining a target image; in which the target image is an image obtained by performing a deformation process on a first image; obtaining a position offset corresponding to a pixel in the target image based on a pixel position in the target image and a pixel position in the target image; and performing anti-aliasing processing on the target image based on the position offset corresponding to the pixel in the target image to obtain a result image; wherein a pixel with a larger position offset corresponds to a larger anti-aliasing processing intensity.

Optionally, the performing anti-aliasing processing on the target image based on the position offset corresponding to the pixel in the target image to obtain a result image, includes: determining an anti-aliasing processing intensity corresponding to the pixel in the target image based on the position offset corresponding to the pixel in the target image; and performing the anti-aliasing processing on the target image based on the anti-aliasing processing intensity corresponding to the pixel in the target image and a present target anti-aliasing algorithm to obtain the result image.

Optionally, the performing the anti-aliasing processing on the target image based on the anti-aliasing processing intensity corresponding to the pixel in the target image and a present target anti-aliasing algorithm to obtain the result image, includes: determining a type to which the present target anti-aliasing algorithm belongs; in which the type includes a first type and a second type, an anti-aliasing algorithm corresponding to the first type has a control parameter for adjusting the anti-aliasing processing intensity, and an anti-aliasing algorithm corresponding to the second type does not have a control parameter for adjusting the anti-aliasing processing intensity; and performing the anti-aliasing processing on the target image based on the anti-aliasing processing intensity corresponding to the pixel in the target image and the type to which the target anti-aliasing algorithm belongs, to obtain the result image.

Optionally, the performing the anti-aliasing processing on the target image based on the anti-aliasing processing intensity corresponding to the pixel in the target image and the type to which the target anti-aliasing algorithm belongs, to obtain the result image, includes: when the type to which the target anti-aliasing algorithm belongs is the first type, obtaining a mapping relationship that is preset; in which the mapping relationship is used to indicate correspondence information between an anti-aliasing processing intensity and a control parameter of the target anti-aliasing algorithm; determining a target value of the control parameter of the target anti-aliasing algorithm based on the anti-aliasing processing intensity corresponding to the pixel in the target image and the mapping relationship; and performing the anti-aliasing processing on the target image by using the target anti-aliasing algorithm based on the target value of the control parameter, to obtain the result image.

Optionally, the performing the anti-aliasing processing on the target image based on the anti-aliasing processing intensity corresponding to the pixel in the target image and the type to which the target anti-aliasing algorithm belongs, to obtain the result image, includes: when the type to which the target anti-aliasing algorithm belongs is the second type, performing the anti-aliasing processing on the target image by using the target anti-aliasing algorithm to obtain a second image; and fusing the target image and the second image based on the anti-aliasing intensity corresponding to the pixel in the target image, to obtain the result image.

Optionally, the fusing the target image and the second image based on the anti-aliasing intensity corresponding to the pixel in the target image, to obtain the result image, includes: determining a first weight corresponding to the pixel in the target image and a second weight corresponding to a pixel in the second image based on the anti-aliasing process intensity corresponding to the pixel in the target image; and weighting a pixel value of the pixel in the target image and a pixel value of the pixel in the second image based on the first weight and the second weight, to obtain the result image.

Optionally, the greater the anti-aliasing processing intensity corresponding to the pixel in the target image is, the smaller the first weight corresponding to the pixel is, and the larger the second weight corresponding to the pixel, at a same position as the pixel in the target image, in the second image is.

Embodiments of the present disclosure further provide an image processing apparatus, which includes: an image obtaining module, configured to obtain a target image; in which the target image is an image obtained by performing a deformation process on a first image; an offset obtaining module, configured to obtain a position offset corresponding to a pixel in the target image based on a pixel position in the target image and a pixel position in the target image; and an anti-aliasing processing module, configured to perform anti-aliasing processing on the target image based on the position offset corresponding to the pixel in the target image to obtain a result image; wherein a pixel with a larger position offset corresponds to a larger anti-aliasing processing intensity.

Embodiments of the present disclosure further provide an electronic device, the electronic device includes: a processing apparatus and a storage apparatus for storing an instruction that is executable by the processing apparatus; the processing apparatus is configured to read the instruction from the storage apparatus to execute the instruction to implement the image processing method as provided by the embodiments of the present disclosure.

Embodiments of the present disclosure further provide a computer-readable storage medium, in which a computer program is stored in the storage medium, and the computer program is used to perform the image processing method as provided by the embodiment of the present disclosure.

### BRIEF DESCRIPTION OF DRAWINGS

The accompanying drawings herein, which are incorporated into the specification and constitute a part of the specification, illustrate embodiments consistent with the present disclosure and together with the specification, serve to explain the principles of the present disclosure.

In order to more clearly illustrate the technical solutions in the embodiments of the present disclosure or the related art, the drawings that need to be used in the description of the embodiments or the related art will be briefly introduced below, and it is obvious that other drawings can be obtained from these drawings without making creative labor for those skilled in the art.

FIG. 1 is a schematic flow diagram of an image processing method according to embodiments of the present disclosure.

FIG. 2 is a schematic diagram of an image processing provided by embodiments of the present disclosure.

FIG. 3 is a schematic diagram of an image processing provided by embodiments of the present disclosure.

FIG. 4 is a schematic structural diagram of an image processing apparatus provided by embodiments of the present disclosure.

FIG. 5 is a schematic structural diagram of an electronic device provided by embodiments of the present disclosure.

### DETAILED DESCRIPTION

In order to make a clearer understanding of the above-described objects, features, and advantages of the present disclosure, solutions of the present disclosure will be further described below. It is to be noted that the features in different embodiments may be combined with each other without conflict.

Numerous specific details are set forth in the following description to facilitate a full understanding of the present disclosure, but the present disclosure may be practiced in other ways than those described herein; obviously, the embodiments in the specification are only some embodiments of the present disclosure, but not all embodiments.

FIG. 1 is a schematic flow diagram of an image processing method provided by embodiments of the present disclosure, and the method can be executed by an image processing apparatus, the apparatus may be implemented in software and/or hardware, and can generally be integrated into an electronic device. As shown in FIG. 1, the method mainly includes the following steps S102 to S106.

Step S102: obtaining a target image; in which the target image is an image obtained by performing a deformation process on a first image. The embodiments of the present disclosure do not limit the manner of the deformation process.

Step S104: obtaining a position offset corresponding to a pixel in the target image based on a pixel position in the target image and a pixel position in the target image. The position offset is the offset distance caused by the deformation process for the pixel. The pixel in the target image may refer to each pixel in the target image, that is, the offset distance of each pixel in the target image before and after the deformation process may be obtained in the embodiments of the present disclosure.

Step S106: performing anti-aliasing processing on the target image based on the position offset corresponding to the pixel in the target image to obtain a result image; in which a pixel with a larger position offset corresponds to a larger anti-aliasing processing intensity. In other words, a pixel with a smaller position offset corresponds to a smaller anti-aliasing processing intensity, and the anti-aliasing processing intensities corresponding to pixels having different position offsets are different.

It can be understood that the positions of the pixels in the first image are different, there may also be differences in the influence of the deformation algorithm on respective pixels, resulting in different position offsets of the pixels before and after deformation. Taking the deformation algorithm including tensile deformation as an example, when a checkerboard is subjected to a tensile deformation, the offset distance of the pixel at a top corner or an edge of the checkerboard is usually large, and the jaggies phenomenon after deformation is obvious, while the offset distance of the pixel near the center of the checkerboard is very small, and the jaggies phenomenon after deformation is not obvious. Therefore, different anti-aliasing processing intensities can be targeted based on the position offset corresponding to each pixel. The above anti-aliasing processing intensity may also be referred to as the anti-aliasing processing degree. For example, the larger the anti-aliasing processing intensity corresponding to the pixel is, the stronger the smoothing processing is indicated for the pixel to improve the smoothing degree between the pixel and a specified pixel around the pixel, and eliminate the aliasing corresponding to the pixel as much as possible. In practical applications, information such as the position and the number of associated pixel(s) participating in smoothing corresponding to the pixel, directivity of smoothing processing, smoothing range and the like can be determined based on the anti-aliasing processing intensity corresponding to the pixel, so that the anti-aliasing processing for the pixel can be realized based on the information.

In the above-described technical solution provided by the embodiments of the present disclosure, it is fully considered that the larger the position offset of the pixel due to deformation is, the more severe the jaggies is; and the smaller the position offset is, the slighter the jaggies is, so that the target image obtained by the deformation processing of the first image can be subjected to anti-aliasing processing based on the position offset corresponding to the pixel in the target image, and the anti-aliasing processing intensity corresponding to the pixel having a larger position offset is greater. The above method does not adopt a consistent anti-aliasing processing intensity for the entire target image, but targeted and corresponding anti-aliasing processing intensity is adopted based on the value of the position offset of the pixel in the target image. For example, in the embodiments of the present disclosure, the pixel with a small position offset corresponds to slight jaggies, and the required anti-aliasing processing intensity is small, so it has little influence on definition. Therefore, the above method not only achieves a better anti-aliasing effect, but also can effectively solve problems such as blurring of the whole image caused by the consistent anti-aliasing processing intensity of the whole image in the related art, and is helpful to better ensure the definition of the obtained image after the anti-aliasing processing.

In some embodiments, the above step S106, that is, the performing anti-aliasing processing on the target image based on the position offset corresponding to the pixel in the target image to obtain a result image can be executed with reference to the following steps A to B.

Step A: determining the anti-aliasing processing intensity corresponding to the pixel in the target image based on the position offset corresponding to the pixel in the target image. In general, the position offset is positively correlated with the anti-aliasing processing intensity, and in practical applications, a mapping relationship between the position offset and the anti-aliasing processing intensity may be set in advance, which is not limited herein.

Step B: performing the anti-aliasing processing on the target image to obtain the result image based on the anti-aliasing processing intensity corresponding to the pixel in the target image and a preset target anti-aliasing algorithm. In the embodiments of the present disclosure, the target anti-aliasing algorithm is not limited, and by the above-described method, targeted processing can be performed based on the anti-aliasing processing intensities corresponding to different pixels and combined with the target anti-aliasing algorithm, thereby simultaneously ensuring the anti-aliasing effect and the definition of the obtained image. Exemplarily, the step B may be performed with reference to the following steps B1 to B2.

Step B1: determining a type to which the preset target anti-aliasing algorithm belongs; in which the type includes a first type and a second type, an anti-aliasing algorithm corresponding to the first type has a control parameter for adjusting the anti-aliasing processing intensity, and an anti-aliasing algorithm corresponding to the second type does not have a control parameter for adjusting the anti-aliasing processing intensity.

Considering that there are a variety of anti-aliasing algorithms currently, the embodiments of the present disclosure divide the anti-aliasing algorithms into the above two types. It should be noted that the anti-aliasing algorithm corresponding to the first type in the related art usually requires artificially setting the anti-aliasing processing intensity, and most of the pixels in the image adopt uniformly artificially set anti-aliasing processing intensity. For example, the anti-aliasing algorithm corresponding to the first type includes an FXAA (Fast Approximate Anti-Aliasing) algorithm, and the smoothness degree can be controlled by a pitch control parameter of sampling points. The anti-aliasing algorithm corresponding to the second type includes an algorithm that uses n * n convolution kernel for anti-aliasing, such as, taking n being 3 as an example, applying 3 * 3 convolution kernel to the image, covering each pixel and its surrounding eight neighboring pixels, thereby performing weighted summation of these pixel values to achieve a smooth anti-aliasing effect. It should be noted that the above anti-aliasing algorithm is merely an example and should not be regarded as a limitation.

Step B2: performing the anti-aliasing processing on the target image based on the anti-aliasing processing intensity corresponding to the pixel in the target image and the type to which the target anti-aliasing algorithm belongs, to obtain the result image. When the type of the target anti-aliasing algorithm is different, the combination mode of the anti-aliasing processing intensity and the target anti-aliasing algorithm is also different. In some embodiments, the above step B2 can be executed with reference to the following steps (1) to (3).

Step (1): when the type to which the target anti-aliasing algorithm belongs is the first type, obtaining a preset mapping relationship; in which the mapping relationship is used to indicate correspondence information between the anti-aliasing processing intensity and the control parameter of the target anti-aliasing algorithm. When the target anti-aliasing algorithm itself has the control parameter for adjusting the anti-aliasing processing intensity, the anti-aliasing processing intensity determined based on the position offset can be directly applied to the algorithm, specifically, the mapping relationship between the anti-aliasing processing intensity and the control parameter can be set in advance, and the specific mapping relationship can be flexibly set according to the principle of the target anti-aliasing algorithm itself actually adopted and the control parameter possessed by the target anti-aliasing algorithm itself, which is not limited here.

Step (2): determining a target value of the control parameter of the target anti-aliasing algorithm based on the anti-aliasing processing intensity and mapping relationship corresponding to the pixel in the target image.

Step (3): based on the target value of the control parameter, performing the anti-aliasing processing on the target image by using the target anti-aliasing algorithm to obtain the result image.

In the related art, it is necessary to artificially set the value of the control parameter, and use the artificial value to process the whole image as a whole. The above method can automatically and reasonably determine the target value of the control parameter based on the anti-aliasing processing intensity corresponding to the pixel, and because the target image includes a plurality of pixels, the anti-aliasing processing intensities corresponding to different pixels may be the same or different, so that when processing the target image by using the target anti-aliasing algorithm, the target value of the control parameter can be dynamically adjusted based on the anti-aliasing processing intensity corresponding to the pixel in target image, so that the anti-aliasing degrees corresponding to the pixels with different position offsets in the target picture are different, and the influence of anti-aliasing processing on definition of the pixel with a low position offset is reduced.

In some embodiments, the above step B2 can be performed with reference to the following steps 1 to 2.

Step 1: when the type to which the target anti-aliasing algorithm belongs is the second type, performing the anti-aliasing processing on the target image by using the target anti-aliasing algorithm to obtain a second image. When the target anti-aliasing algorithm itself does not have the adjustment ability, the algorithm can be used to uniformly process the image first to obtain the second image.

Step 2: based on the anti-aliasing processing intensity corresponding to the pixel in the target image, fusing the target image and the second image to obtain the result image. It can be understood that when all pixels in the target image are uniformly processed by the anti-aliasing algorithm without any difference, the overall second image obtained is blurring and the definition is poor. Therefore, the clear target image and the unclear second pixel can be fused based on the anti-aliasing processing intensity corresponding to the pixel in the target image, so as to reduce the influence of the anti-aliasing processing on definition and improve the definition of the image. In some specific embodiment examples, the above step 2 can be performed with reference to steps 2.1 to 2.2.

Step 2.1: determining a first weight corresponding to the pixel in the target image and a second weight corresponding to a pixel in the second image based on the anti-aliasing processing intensity corresponding to the pixel in the target image.

Exemplarily, the greater the anti-aliasing processing intensity corresponding to the pixel in the target image is, the smaller the first weight corresponding to the pixel is, and the larger the second weight corresponding to the pixel, at the same position as the pixel in the target image, in the second image is. In a practical application, a mapping relationship between the anti-aliasing processing intensity and the first weight and the second weight can be determined, and for example, assuming that the anti-aliasing processing intensity is a value between 0 and 1, the anti-aliasing processing intensity can be directly made equal to the second weight, and the difference between 1 and the anti-aliasing processing intensity can be made equal to the first weight.

Step 2.2: based on the first weight and the second weight, weighting a pixel value of the pixel in the target image and a pixel value of the pixel in the second pixel, to obtain the result image.

It should be illustrated that the weighting process is to perform a weighting process for the pixel values of the pixels having the same position in the target image and the second image, and the result of the weighting process is used as the pixel value of the pixel at the above same position in the result image, and the pixel values of each position in the target and the second pixel value are weighted in the above manner to obtain the result image.

It is understandable that the proportion of the pixel value of the pixel in the target image and the proportion of the pixel value of the pixel in the second image can be effectively adjusted through the above manner. For example, assuming that the pixel A is greatly affected by the deformation algorithm, has a large position offset, and has obvious jaggies, the corresponding anti-aliasing processing intensity is high, and the pixel value of the pixel A in the result image is closer to the pixel value of the pixel in the second image, to achieve a better smoothing effect. Assuming that the pixel A is less affected by the deformation algorithm, the position offset is small, and the jaggies phenomenon is not obvious, the corresponding anti-aliasing treatment intensity is small, and the pixel value of the pixel A in the result image is closer to the pixel value of the pixel in the target image, so as to ensure definition. Through the above method, the fusion proportion/ratio between the target image and the second image can be dynamically and reasonably determined based on the anti-aliasing processing intensity corresponding to each pixel, thereby ensuring not only the definition of the image as much as possible, but also the anti-aliasing effect.

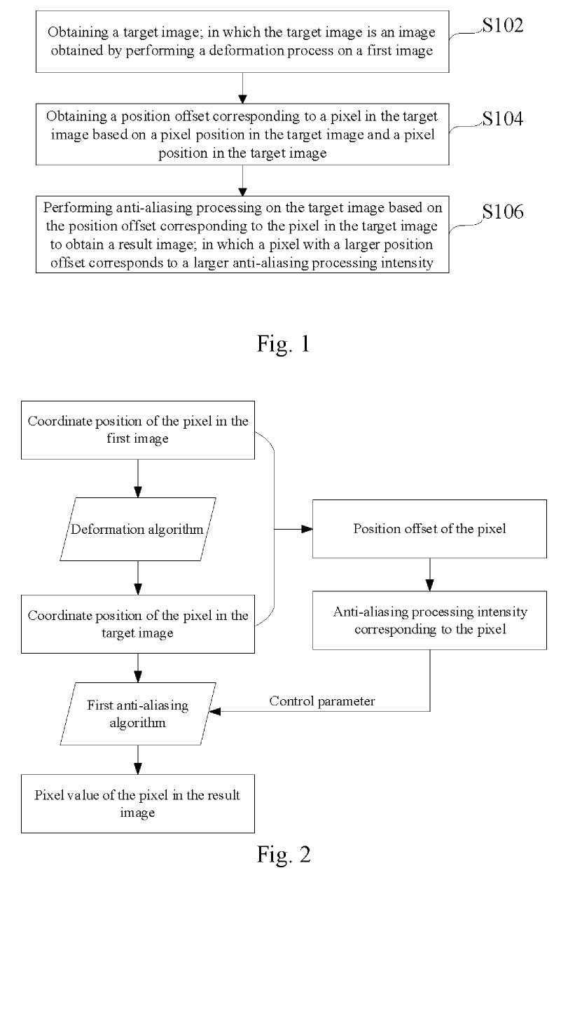

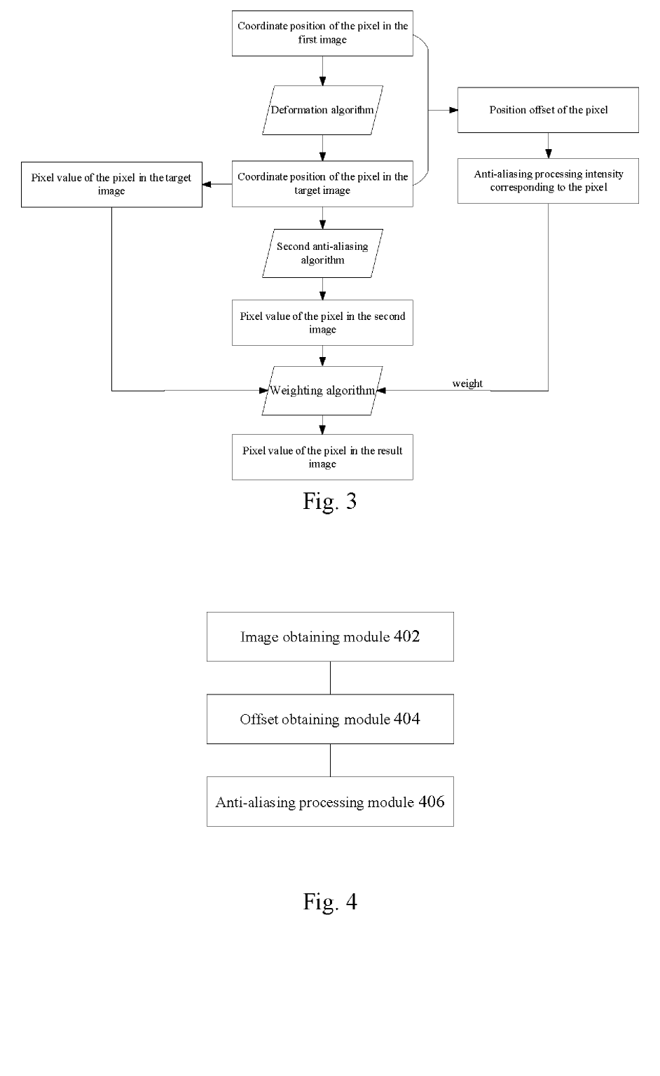

In order to facilitate understanding, the embodiments of the present disclosure provide schematic diagrams of an image processing as shown in FIG. 2 and FIG. 3, respectively, which will be briefly described below.

The target image is obtained from a first image through a deformation algorithm, and FIG. 2 shows that the coordinate position of the pixel in the first image is processed by the deformation algorithm to obtain the coordinate position of the pixel in the target image. Based on the coordinate position of the pixel in the first image and the coordinate position of the pixel in the target image, the position offset of the pixel can be calculated, and the anti-aliasing processing intensity corresponding to the pixel is determined based on the position offset, and then the first anti-aliasing algorithm is used to process based on the anti-aliasing processing intensity and the target image to obtain the pixel value of the pixel in the result image. The first anti-aliasing algorithm has a control parameter for adjusting the anti-aliasing processing intensity, and the anti-aliasing processing intensity obtained based on the position offset can be introduced into the first anti-aliasing algorithm based on the mapping relationship between the anti-aliasing processing intensity and the control parameter, thereby directly using the first anti-aliasing algorithm to process the target image to obtain the result image.

The difference between FIG. 3 and FIG. 2 lies in the different anti-aliasing algorithms adopted. The second anti-aliasing algorithm adopted in FIG. 3 does not have the control parameter for adjusting the anti-aliasing intensity. Therefore, a second anti-aliasing algorithm is needed to process the target image first to obtain a second image, and then determine corresponding weights of the respective pixels of the second image and the target image based on the anti-aliasing processing intensity of the pixel, and then perform weighting processing on the pixel value of the pixel in the second image and the pixel value of the pixel in the target image to finally obtain the result image.

In summary, the image processing method provided by the embodiments of the present disclosure fully considers that the larger the position offset of the pixel caused by deformation is, the more serious the jaggies is; and the smaller the position offset is, the slighter the jaggies is, so that the corresponding anti-aliasing processing intensity is targeted based on the amount of the position offset of the pixel in the target image, instead of applying consistent anti-aliasing processing intensity to pixels of the entire target image obtained through deformation processing, this method can effectively solve the problem of the blurring of the whole image caused by the adoption of the consistent anti-aliasing processing intensity for the whole image in the related technology while achieving a better anti-aliasing effect, and help to better ensure the definition of the image obtained after the anti-aliasing processing.

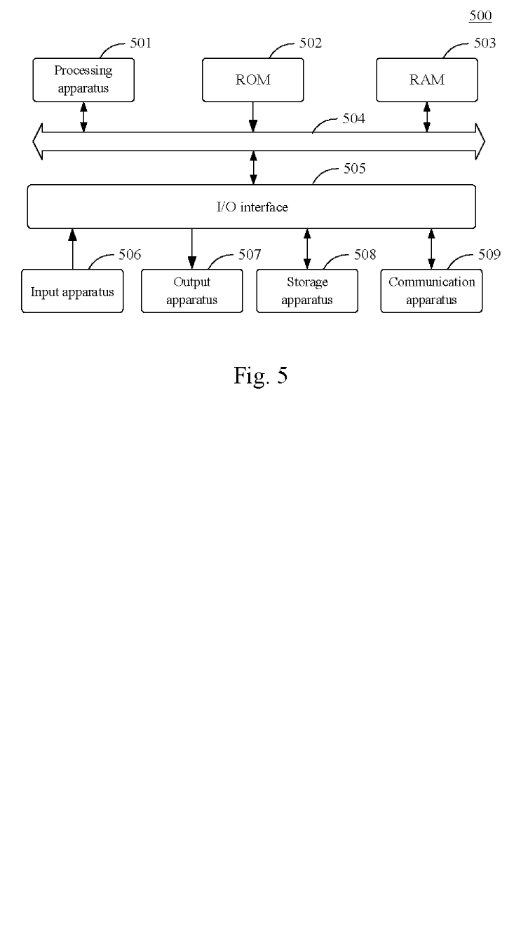

The embodiments of the present disclosure further provide an image processing apparatus. FIG. 4 is a schematic structural diagram of an image processing apparatus provided by the embodiments of the present disclosure. The apparatus can be implemented by software and/or hardware, and can generally be integrated into an electronic device. As shown in FIG. 4, the apparatus includes:

an image obtaining module 402, configured to acquire a target image; in which target image is an image obtained by performing a deformation process on a first image;

an offset obtaining module 404, configured to obtain a position offset corresponding to a pixel in the target image based on a pixel position in target image and a pixel position in the first image; and

an anti-aliasing processing module 406, configured to perform anti-aliasing processing on the target image based on a position offset corresponding to the pixel in the target image to obtain a result image; in which a pixel with a larger position offset corresponds to a larger anti-aliasing processing intensity.

The above-described apparatus provided by the embodiments of the present disclosure fully considers that the larger the position offset of the pixel caused by deformation is, the more serious the jaggies is; and the smaller the position offset is, the slighter the jaggies is, so that for the target image obtained by the deformation processing on the first image, the anti-aliasing processing can be performed on the target image based on the amount of the position offset corresponding to the pixel in the target image, and the anti-aliasing processing intensity corresponding to the pixel having a larger position offset is greater. The above method does not adopt a consistent anti-aliasing processing intensity for the entire target image, but targeted and corresponding anti-aliasing processing intensity is adopted based on the amount of the position offset of the pixel in the target image. For example, in the embodiments of the present disclosure, the pixel with a small position offset corresponds to slight jaggies, and the required anti-aliasing processing intensity is small, so it has little influence on definition. Therefore, the above method not only achieves a better anti-aliasing effect, but also can effectively solve problems such as blurring of the whole image caused by the consistent anti-aliasing processing intensity performed on the whole image in the related art, and is helpful to better ensure the definition of the obtained image after the anti-aliasing processing.

In some embodiments, the anti-aliasing processing module 406 is specifically configured to: determine an anti-aliasing processing intensity corresponding to pixel in the target image based on a position offset corresponding to pixel in the target image; anti-aliasing processing is performed on the target image based on an anti-aliasing processing intensity corresponding to the pixel in the target image and a preset target anti-aliasing algorithm to obtain a result image.

In some embodiments, the anti-aliasing processing module 406 is specifically configured to: determine an anti-aliasing processing intensity corresponding to the pixel in the target image based on the position offset corresponding to the pixel in the target image; and perform the anti-aliasing processing on the target image based on the anti-aliasing processing intensity corresponding to the pixel in the target image and a preset target anti-aliasing algorithm to obtain the result image.

In some embodiments, the anti-aliasing processing module 406 is specifically configured to: determine a type to which the preset target anti-aliasing algorithm belongs; in which the type includes a first type and a second type, an anti-aliasing algorithm corresponding to the first type has a control parameter for adjusting the anti-aliasing processing intensity, and an anti-aliasing algorithm corresponding to the second type does not have a control parameter for adjusting the anti-aliasing processing intensity; and perform the anti-aliasing processing on the target image based on the anti-aliasing processing intensity corresponding to the pixel in the target image and the type to which the target anti-aliasing algorithm belongs, to obtain the result image.

In some embodiments, the anti-aliasing processing module 406 is specifically configured to: when the type to which the target anti-aliasing algorithm belongs is the first type, obtaining a mapping relationship that is preset; in which the mapping relationship is used to indicate correspondence information between an anti-aliasing processing intensity and a control parameter of the target anti-aliasing algorithm; determine a target value of the control parameter of the target anti-aliasing algorithm based on the anti-aliasing processing intensity corresponding to the pixel in the target image and the mapping relationship; and perform the anti-aliasing processing on the target image by using the target anti-aliasing algorithm based on the target value of the control parameter, to obtain the result image.

In some embodiments, the anti-aliasing processing module 406 is specifically configured to: when the type to which the target anti-aliasing algorithm belongs is the second type, perform the anti-aliasing processing on the target image by using the target anti-aliasing algorithm to obtain a second image; and fuse the target image and the second image based on the anti-aliasing intensity corresponding to the pixel in the target image, to obtain the result image.

In some embodiments, the anti-aliasing processing module 406 is specifically configured to: determine a first weight corresponding to the pixel in the target image and a second weight corresponding to a pixel in the second image based on the anti-aliasing process intensity corresponding to the pixel in the target image; and weight a pixel value of the pixel in the target image and a pixel value of the pixel in the second image based on the first weight and the second weight, to obtain the result image.

In some embodiments, the greater the anti-aliasing processing intensity corresponding to the pixel in the target image is, the smaller the first weight corresponding to the pixel is, and the larger the second weight corresponding to the pixel, at the same position as the pixel in the target image, in the second image is.

The image processing apparatus provided by the embodiments of the present disclosure can execute the image processing method provided by any embodiment of the present disclosure, and has functional modules and beneficial effects corresponding to the method.

Those skilled in the art can clearly understand that, for convenience and conciseness of the description, for the specific working process of the apparatus embodiment described above, references can be made to the corresponding process in the method embodiments, which will not be repeated here.

The embodiments of the present disclosure provide an electronic device, the electronic device includes: a storage apparatus on which a computer program is stored; and a processing apparatus for executing the computer program in the storage apparatus to implement the steps of any one of the methods provided by the embodiments of the present disclosure.

Referring to FIG. 5, FIG. 5 illustrates a schematic structural diagram of an electronic device 500 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 5 is merely an example, and should not pose any limitation to the functions and the range of use of the embodiments of the present disclosure.

As illustrated in FIG. 5, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

In addition to the method and apparatus described above, embodiments of the present disclosure may also provide a computer program product including computer a program instruction, when the computer program instruction is executed by a processing apparatus, the processing apparatus is caused to perform the image processing method provided by the embodiments of the present disclosure. The computer program product for performing the operations of the present disclosure may include a program code written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user’s computer, partly on the user’s computer, as a stand-alone software package, partly on the user’s computer and partly on a remote computer, or entirely on the remote computer or server.

In addition, the embodiments of the present disclosure may also provide a computer-readable storage medium, storing a computer program, when the computer program is run on a processing apparatus, the processing apparatus is caused to perform the image processing method provided by the embodiments of the present disclosure.

The above-mentioned computer-readable storage medium may be one readable medium of a combination of a plurality of readable media. The readable medium may be a readable signal medium or a readable storage medium. For example, the readable storage medium may be, but not limited to, an electric, magnetic, optical, electromagnetic, infrared, or semiconductor system, apparatus or device, or any combination thereof. More specific examples of the readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them.

Embodiments of the present disclosure also provide a computer program product, which includes a computer program/instruction, and when the computer program/instruction is executed by a processing apparatus, the processing apparatus is caused to perform the image processing method provided by the embodiments of the present disclosure.

It can be understood that before the technical solution disclosed in each embodiment of the present disclosure is used, the user should be informed of the type, use scope, use scenario, and the like of the personal information involved in the present disclosure in an appropriate manner in accordance with relevant laws and regulations, and the user's authorization should be obtained.

For example, when a user's active request is received, prompt information is sent to the user to explicitly prompt the user that the operation requested by the user will need to obtain and use the user's personal information. Therefore, the user can independently choose whether to provide personal information to software or hardware such as an electronic device, an application, a server, or a storage medium that executes the operation of the technical solution of the present disclosure based on the prompt information.

As an optional but non-limiting implementation, in response to receiving the user's active request, for example, the prompt information may be sent to the user in a pop-up window, and the prompt information may be presented in the pop-up window in text. In addition, the pop-up window may also carry a selection control for the user to select "agree" or "disagree" to provide personal information to the electronic device.

It can be understood that the above notification and user authorization obtaining process are only illustrative and do not limit the implementations of the present disclosure. Other methods that comply with relevant laws and regulations may also be applied to the implementations of the present disclosure.

In addition, it can be understood that the data involved in this technical solution (including but not limited to the data itself, the acquisition or use of data) should comply with the requirements of corresponding laws and regulations and related regulations.

It should be noted that relational terms such as "first" and "second" are used herein only to distinguish between one entity or operation and another entity or operation, and are not necessarily intended to require or imply any actual relationship or order between these entities or operations. Moreover, the term "include/comprise" or any other variation thereof is intended to cover a non-exclusive inclusion, such that a process, method, article, or device that includes a list of elements includes not only those elements but also other elements not expressly listed, or elements that are inherent to such a process, method, article, or device. Without more limitations, an element defined by a statement "include/comprise one..." does not exclude that there are other same elements in the process, method, article, or device that includes the element.

The above are only specific implementations of the present disclosure, and enable those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure is not limited to these embodiments described herein, but is to be accorded the widest scope consistent with the principles and novel features disclosed herein.

1. An image processing method, comprising:
obtaining a target image; wherein the target image is an image obtained by performing a deformation process on a first image;
obtaining a position offset corresponding to a pixel in the target image based on a pixel position in the target image and a pixel position in the target image; and
performing anti-aliasing processing on the target image based on the position offset corresponding to the pixel in the target image to obtain a result image; wherein a pixel with a larger position offset corresponds to a larger anti-aliasing processing intensity.

2. The method according to claim 1, wherein the performing anti-aliasing processing on the target image based on the position offset corresponding to the pixel in the target image to obtain a result image, comprises:
determining an anti-aliasing processing intensity corresponding to the pixel in the target image based on the position offset corresponding to the pixel in the target image; and
performing the anti-aliasing processing on the target image based on the anti-aliasing processing intensity corresponding to the pixel in the target image and a preset target anti-aliasing algorithm to obtain the result image.

3. The method according to claim 2, wherein the performing the anti-aliasing processing on the target image based on the anti-aliasing processing intensity corresponding to the pixel in the target image and a preset target anti-aliasing algorithm to obtain the result image, comprises:
determining a type to which the preset target anti-aliasing algorithm belongs; wherein the type comprises a first type and a second type, an anti-aliasing algorithm corresponding to the first type has a control parameter for adjusting the the anti-aliasing processing intensity, and an anti-aliasing algorithm corresponding to the second type does not have a control parameter for adjusting the anti-aliasing processing intensity; and
performing the anti-aliasing processing on the target image based on the anti-aliasing processing intensity corresponding to the pixel in the target image and the type to which the target anti-aliasing algorithm belongs, to obtain the result image.

4. The method according to claim 3, wherein the performing the anti-aliasing processing on the target image based on the anti-aliasing processing intensity corresponding to the pixel in the target image and the type to which the target anti-aliasing algorithm belongs, to obtain the result image, comprises:
when the type to which the target anti-aliasing algorithm belongs is the first type, obtaining a mapping relationship that is preset; wherein the mapping relationship is used to indicate correspondence information between an anti-aliasing processing intensity and a control parameter of the target anti-aliasing algorithm;
determining a target value of the control parameter of the target anti-aliasing algorithm based on the anti-aliasing processing intensity corresponding to the pixel in the target image and the mapping relationship; and
performing the anti-aliasing processing on the target image by using the target anti-aliasing algorithm based on the target value of the control parameter, to obtain the result image.

5. The method according to claim 3, wherein performing the anti-aliasing processing on the target image based on the anti-aliasing processing intensity corresponding to the pixel in the target image and the type to which the target anti-aliasing algorithm belongs, to obtain the result image, comprises:
when the type to which the target anti-aliasing algorithm belongs is the second type, performing the anti-aliasing processing on the target image by using the target anti-aliasing algorithm to obtain a second image; and
fusing the target image and the second image based on the anti-aliasing intensity corresponding to the pixel in the target image, to obtain the result image.

6. The method according to claim 5, wherein the fusing the target image and the second image based on the anti-aliasing intensity corresponding to the pixel in the target image, to obtain the result image, comprises:
determining a first weight corresponding to the pixel in the target image and a second weight corresponding to a pixel in the second image based on the anti-aliasing process intensity corresponding to the pixel in the target image; and
weighting a pixel value of the pixel in the target image and a pixel value of the pixel in the second image based on the first weight and the second weight, to obtain the result image.

7. The method according to claim 6, wherein the greater the anti-aliasing processing intensity corresponding to the pixel in the target image is, the smaller the first weight corresponding to the pixel is, and the larger the second weight corresponding to the pixel, at a same position as the pixel in the target image, in the second image is.

8. An electronic device, comprising:
a storage apparatus, storing a computer program thereon; and
a processing apparatus, configured to execute the computer program in the storage apparatus to:
obtain a target image; wherein the target image is an image obtained by performing a deformation process on a first image;
obtain a position offset corresponding to a pixel in the target image based on a pixel position in the target image and a pixel position in the target image; and
perform anti-aliasing processing on the target image based on the position offset corresponding to the pixel in the target image to obtain a result image; wherein a pixel with a larger position offset corresponds to a larger anti-aliasing processing intensity.

9. The electronic device according to claim 8, wherein the processing apparatus is further configured to:
determine an anti-aliasing processing intensity corresponding to the pixel in the target image based on the position offset corresponding to the pixel in the target image; and
perform the anti-aliasing processing on the target image based on the anti-aliasing processing intensity corresponding to the pixel in the target image and a present target anti-aliasing algorithm to obtain the result image.

10. The electronic device according to claim 9, wherein the processing apparatus is further configured to:
determine a type to which the present target anti-aliasing algorithm belongs; wherein the type comprises a first type and a second type, an anti-aliasing algorithm corresponding to the first type has a control parameter for adjusting the the anti-aliasing processing intensity, and an anti-aliasing algorithm corresponding to the second type does not have a control parameter for adjusting the anti-aliasing processing intensity; and
perform the anti-aliasing processing on the target image based on the anti-aliasing processing intensity corresponding to the pixel in the target image and the type to which the target anti-aliasing algorithm belongs, to obtain the result image.

11. The electronic device according to claim 10, wherein the processing apparatus is further configured to:
when the type to which the target anti-aliasing algorithm belongs is the first type, obtain a mapping relationship that is preset; wherein the mapping relationship is used to indicate correspondence information between an anti-aliasing processing intensity and a control parameter of the target anti-aliasing algorithm;
determine a target value of the control parameter of the target anti-aliasing algorithm based on the anti-aliasing processing intensity corresponding to the pixel in the target image and the mapping relationship; and
perform the anti-aliasing processing on the target image by using the target anti-aliasing algorithm based on the target value of the control parameter, to obtain the result image.

12. The electronic device according to claim 10, wherein the processing apparatus is further configured to:
when the type to which the target anti-aliasing algorithm belongs is the second type, perform the anti-aliasing processing on the target image by using the target anti-aliasing algorithm to obtain a second image; and
fuse the target image and the second image based on the anti-aliasing intensity corresponding to the pixel in the target image, to obtain the result image.

13. The electronic device according to claim 12, wherein the processing apparatus is further configured to:
determine a first weight corresponding to the pixel in the target image and a second weight corresponding to a pixel in the second image based on the anti-aliasing process intensity corresponding to the pixel in the target image; and
weight a pixel value of the pixel in the target image and a pixel value of the pixel in the second image based on the first weight and the second weight, to obtain the result image.

14. The electronic device according to claim 13, wherein the greater the anti-aliasing processing intensity corresponding to the pixel in the target image is, the smaller the first weight corresponding to the pixel is, and the larger the second weight corresponding to the pixel, at a same position as the pixel in the target image, in the second image is.

15. A non-transitory computer-readable storage medium, storing a computer program, wherein the computer program is configured to be executed by at least one processor and cause the at least one processor to:
obtain a target image; wherein the target image is an image obtained by performing a deformation process on a first image;
obtain a position offset corresponding to a pixel in the target image based on a pixel position in the target image and a pixel position in the target image; and
perform anti-aliasing processing on the target image based on the position offset corresponding to the pixel in the target image to obtain a result image; wherein a pixel with a larger position offset corresponds to a larger anti-aliasing processing intensity.

16. The medium according to claim 15, wherein the processor is further caused to:
determine an anti-aliasing processing intensity corresponding to the pixel in the target image based on the position offset corresponding to the pixel in the target image; and
perform the anti-aliasing processing on the target image based on the anti-aliasing processing intensity corresponding to the pixel in the target image and a present target anti-aliasing algorithm to obtain the result image.

17. The medium according to claim 16, wherein the processor is further caused to:
determine a type to which the present target anti-aliasing algorithm belongs; wherein the type comprises a first type and a second type, an anti-aliasing algorithm corresponding to the first type has a control parameter for adjusting the the anti-aliasing processing intensity, and an anti-aliasing algorithm corresponding to the second type does not have a control parameter for adjusting the anti-aliasing processing intensity; and
perform the anti-aliasing processing on the target image based on the anti-aliasing processing intensity corresponding to the pixel in the target image and the type to which the target anti-aliasing algorithm belongs, to obtain the result image.

18. The medium according to claim 17, wherein the processor is further caused to:
when the type to which the target anti-aliasing algorithm belongs is the first type, obtain a mapping relationship that is preset; wherein the mapping relationship is used to indicate correspondence information between an anti-aliasing processing intensity and a control parameter of the target anti-aliasing algorithm;
determine a target value of the control parameter of the target anti-aliasing algorithm based on the anti-aliasing processing intensity corresponding to the pixel in the target image and the mapping relationship; and
perform the anti-aliasing processing on the target image by using the target anti-aliasing algorithm based on the target value of the control parameter, to obtain the result image.

19. The medium according to claim 17, wherein the processor is further caused to:
when the type to which the target anti-aliasing algorithm belongs is the second type, perform the anti-aliasing processing on the target image by using the target anti-aliasing algorithm to obtain a second image; and
fuse the target image and the second image based on the anti-aliasing intensity corresponding to the pixel in the target image, to obtain the result image.

20. The medium according to claim 19, wherein the processor is further caused to:
determine a first weight corresponding to the pixel in the target image and a second weight corresponding to a pixel in the second image based on the anti-aliasing process intensity corresponding to the pixel in the target image; and
weight a pixel value of the pixel in the target image and a pixel value of the pixel in the second image based on the first weight and the second weight, to obtain the result image.
